(19) United States
(12) Patent Application Publication
(10) Pub. No.: US 2006/0293993 A1
(43) Pub. Date: Dec. 28, 2006

(54) Suggesting and selecting a service provider to provide a service for a journey

(75) Inventor: Jonathan Dale, San Francisco, CA (US)

Correspondence Address: BAKER BOTTS L.L.P., 2001 ROSS AVENUE, SUITE 600, DALLAS, TX, 75201-2980, US

(73) Assignee: Fujitsu Limited

(21) Appl. No.: 11/165,400

(22) Filed: Jun. 23, 2005

(51) Int. Cl. G06Q 40/00; G07G 1/00; G01C 21/30; G07B 13/04; G06F 17/30; G01C 21/32; G06F 17/00; G07B 15/02

(52) U.S. Cl. 705/37; 705/10; 705/417; 701/209

(57) ABSTRACT

Planning a journey includes planning the journey from an origin to a destination. A service along the journey is suggested. Bids for the service are requested from service providers, and the bids are received from the service providers. The service providers are evaluated in accordance with the bids. One or more service providers are selected in response to the evaluation.

### TECHNICAL FIELD

This invention relates generally to the field of journey planning and more specifically to suggesting and selecting a service provider to provide a service for a journey.

### BACKGROUND

Journey planning involves establishing a route between an origin and a destination. The route may include waypoints between the origin and the destination. Existing techniques for journey planning involve planning a route that satisfies specified parameters. For example, the route may be planned to satisfy a starting time and an ending time. Most existing techniques, however, provide rigid offerings that do little to simplify or automate journey planning.

### SUMMARY OF THE DISCLOSURE

In accordance with the present invention, disadvantages and problems associated with previous techniques for journey planning may be reduced or eliminated.

According to one embodiment of the invention, planning a journey includes planning the journey from an origin to a destination. A service along the journey is suggested. Bids for the service are requested from service providers, and the bids are received from the service providers. The service providers are evaluated in accordance with the bids. One or more service providers are selected in response to the evaluation.

Certain embodiments of the invention may provide one or more technical advantages. A technical advantage of one embodiment may be that services for a journey may be automatically suggested using service suggestion criteria. The service suggestion criteria may be organized into contexts, which apply to different types of journeys. Another technical advantage of one embodiment may be that bids for providing a service for may be requested from a number of service providers. The service providers may then compete to provide the service. Another technical advantage of one embodiment may be that the service providers may access advertisements requesting the bids. The service providers may thus readily identify users requesting their services.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 is a diagram illustrating a journey that may be planned according to one embodiment of the invention;

FIG. 2 is a block diagram illustrating one embodiment of a system that may be used to plan a journey;

FIG. 3 is a block diagram illustrating one embodiment of a bargaining module that may be used with the system of FIG. 2; and

FIG. 4 is a flowchart illustrating one embodiment of a method for planning a journey that may be used with the system of FIG. 2.

### DETAILED DESCRIPTION OF THE DRAWINGS

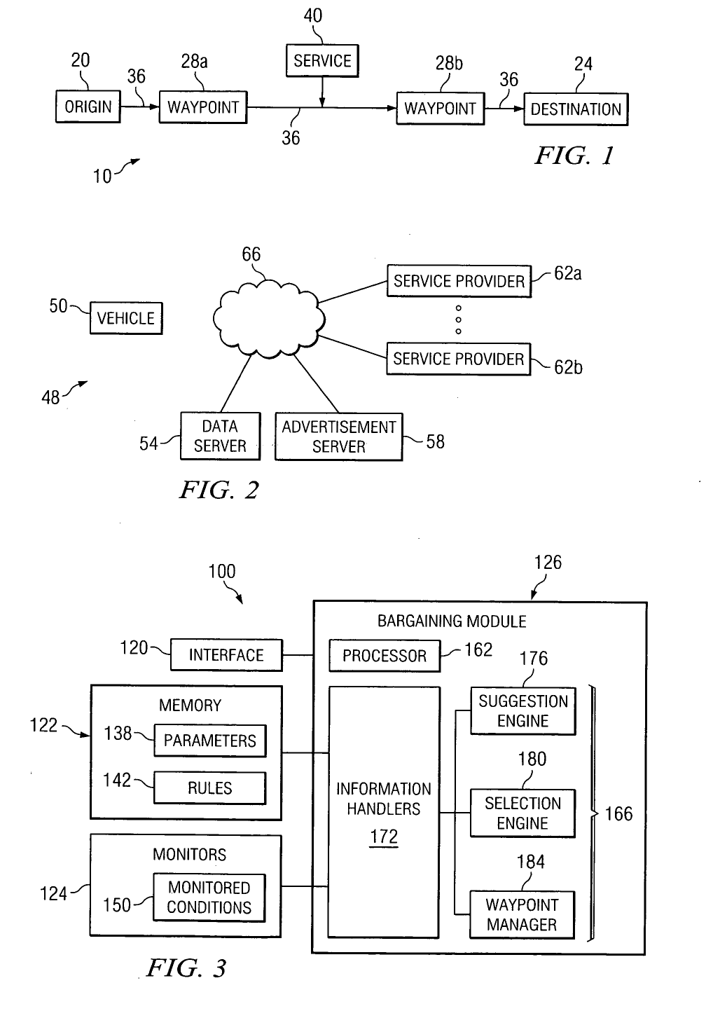

Embodiments of the present invention and its advantages are best understood by referring to FIGS. 1 through 4 of the drawings, like numerals being used for like and corresponding parts of the various drawings.

FIG. 1 is a diagram illustrating a journey 10 that may be planned according to one embodiment of the invention. According to the embodiment, a route between an origin and a destination of journey 10 may be planned for a user traveling on journey 10. A service may be suggested to the user. Bids to provide the service may be requested from service providers. Service providers may submit bids, and a service provider may be selected according to the bids.

A journey may refer to a plurality of points and a route traveled by a user along the points. A user may refer to the entity traveling along the route of a journey. A user typically represents a human, but may represent a non-human object. As an example, a user may represent a computer or other object that can approve suggestions for a service.

A point may refer to a location such as a geographical location. As an example, a point may represent an address, a building, a place of business, geographical coordinates, other location, or any combination of the preceding. A point may represent a location where a service is provided. For example, a point may represent an automobile service station, a restaurant, a hotel, an attraction, a store, a business, a company, other service location, or any combination of the preceding.

According to the illustrated embodiment, points include an origin 20, a destination 24, and waypoints 28. Origin 20 represents the starting point of journey 10, and destination 24 represents the ending point of journey 10. Waypoints 28 represent intermediate points of journey 10 between origin 20 and destination 24. A route 36 may refer to a path along the points.

A point description provides information about a point. The information may allow for selection of a waypoint according to selection criteria. A point description may include a location description that provides the geographical location of the point, which may be given by an address, global positioning system coordinates, other description of location, or any combination of the preceding. The location description may also provide a physical description of the point. The physical description may include a building description, a parking description, or other physical information about the point.

According to one embodiment, a service 40 may be suggested to the user along the route. A service may refer to a product, an action, a space, or other entity that may be purchased or rented in return for compensation. Example services include those provided by restaurants, hotels, stores, gas stations, entertainment venues, other service providers, or any combination of the preceding. Service 40 may be automatically suggested in accordance with suggestion criteria.

Service 40 may be automatically suggested in accordance with suggestion criteria such as parameters, rules, and conditions. According to one embodiment, journey contexts that describe typical services 40 for certain types of journeys may also be used to suggest a service 40. According to the embodiment, parameters, rules, and conditions may be analyzed to establish an appropriate context. The context may then be used to determine services to suggest.

If the user approves the suggested service 40, advertisements requesting bids to provide service 40 may be made available to service providers. An advertisement requesting a bid may refer to a notice designed to elicit bids. A bid to provide a service may refer to a proposal to provide the service, and typically includes conditions under which the service will be provided and the compensation expected in exchange for the service. Service providers may submit bids, and a service provider may be selected in response to the bids according to selection criteria. An example system is described in more detail with reference to FIG. 2.

Modifications, additions, or omissions may be made to journey 10 without departing from the scope of the invention. For example, journey 10 may include more or fewer points configured in any suitable matter. Moreover, the routes among the points may be configured in any suitable matter. As used in this document, “each” refers to each member of a set or each member of a subset of a set.

FIG. 2 is a block diagram illustrating one embodiment of a network system 48 that may be used to plan a journey. According to the illustrated embodiment, network system 48 includes a vehicle 50, a data server 54, an advertisement server 58, one or more service providers 62, and a communication network 66 coupled as shown. According to one embodiment, the user is traveling in a vehicle 50. Vehicle 50 may represent any suitable transporter for the user, such as an automobile, an airplane, or a motorcycle.

According to one embodiment, vehicle 50 includes a bargaining module. A bargaining module is operable to suggest a service, request bids from service providers, and select a service provider in response to the bids. The bargaining module is described in more detail with reference to FIG. 3. According to another embodiment, the user is not traveling in vehicle 50 but is carrying the bargaining module. As an example, the user may be carrying the bargaining module while walking down the street or in an office.

Advertisement server 58 may be used to make an advertisement available for use by service provider 62. Advertisement server 58 may receive an advertisement from the bargaining module of vehicle 50, and may provide the advertisement to service provider 62 in any suitable manner. As an example, advertisement server 58 may provide a website where service provider 62 may access the advertisement. As another example, advertisement server 58 may send the advertisement to service provider 62. As yet another example, advertisement server 58 may broadcast or multicast the advertisement to service provider 62. The advertisement, however, may be made available to service provider 62 in any other suitable manner. As an example, data server 54 or vehicle 50 may directly provide the advertisement to service provider 62.

A service provider 62 represents any suitable entity operable to provide a service. Service providers 62 may offer machine readable interfaces that enable queries to access and interact with information regarding the services. For example, a particular service provider 62 may provide access to and interaction with a restaurant reservation system. To provide these operations, a service may support any number of features and provide an interface to each one of these features. For example, a restaurant reservation service may offer features such as a reservation availability query feature or a reservation request feature.

Network 66 represents a communication network that allows devices to communicate with other devices. A communication network may comprise all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, other suitable communication link, or any combination of the preceding.

A component of system 48 may include logic, an interface, memory, other component, or any suitable combination of the preceding. “Logic” may refer to hardware, software, other logic, or any suitable combination of the preceding. Certain logic may manage the operation of a device, and may comprise, for example, a processor. “Processor” may refer to any suitable device operable to execute instructions and manipulate data to perform operations. “Interface” may refer to logic of a device operable to receive input for the device, send output from the device, perform suitable processing of the input or output or both, or any combination of the preceding, and may comprise one or more ports, conversion software, or both.

“Memory” may refer to logic operable to store and facilitate retrieval of information, and may comprise Random Access Memory (RAM), Read Only Memory (ROM), a magnetic drive, a disk drive, a Compact Disk (CD) drive, a Digital Video Disk (DVD) drive, removable media storage, any other suitable data storage medium, or a combination of any of the preceding.

Modifications, additions, or omissions may be made to system 48 without departing from the scope of the invention. The components of system 48 may be integrated or separated according to particular needs. Moreover, the operations of system 48 may be performed by more, fewer, or other modules. Additionally, operations of system 48 may be performed using any suitable logic comprising software, hardware, other logic, or any suitable combination of the preceding.

FIG. 3 is a block diagram illustrating one embodiment of a system 100 that includes a bargaining module. According to the illustrated embodiment, system 100 includes an interface 120, a memory 122, monitors 124, and a bargaining module 126 coupled as shown. Interface 120 allows a user such as a traveler to communicate with bargaining module 126. Bargaining module 126 is operable to suggest a service to the user, distribute advertisements requesting bids to provide the service, and select a service provider in response to the bids.

Bargaining module 126 may use criteria to suggest a service and to select a service provider. Service suggestion criteria may be used to suggest a service, and service provider selection criteria may be used to select a service provider. The criteria may include journey parameters, monitored conditions, rules, or any combination of the preceding, and may be provided by memory 122, data server 54 of FIG. 2, monitors 124, or other source.

According to the illustrated example, memory 122 stores parameters 138 and rules 142, and monitors 124 provide monitored conditions 150. A journey parameter 138 may refer to a value that remains generally constant during journey 10. Journey parameters 138 may change in certain cases, but in general remain constant. A journey parameter 138 may include a route parameter or a user preference or a combination of both.

A route parameter describes parameters of the route. According to one embodiment, route parameters may be obtained from the itinerary of the user, which may be stored in a program such as MICROSOFT OUTLOOK. Route parameters may include a point parameter, a time parameter, or a combination of both. A point parameter describes a point of journey 10. For example, point parameters may specify origin 20 and destination 24 or required and optional waypoints 28.

A time parameter describes the time specifications of journey 10. For example, time parameters may include the maximum time allowed to travel from origin 20 to destination 24, the maximum time allowed to travel from one point to another point, the minimum or maximum amount of time to spend at a particular point, the time at which the user must arrive or leave a particular point, other suitable time parameter, or any combination of the preceding. A time parameter may also include a time variation within which the time parameter is permitted to vary.

A user preference describes a feature of a service that the user prefers. For example, user preferences may describe a preferred chain of hotel, restaurant, service station, or other place of business. User preferences may describe a preferred type of point, such a restaurant that serves a particular type of food, for example, Italian or Chinese food, or a restaurant with a specific average meal price.

Monitors 124 provide monitored conditions 150. Monitored conditions 150 refer to conditions of journey 10 that may vary during journey 10. Monitored conditions 150 may, of course, remain constant during journey 10, but typically have a possibility of variation. Monitors 124 may include a vehicle condition monitor, an external monitor, other monitor, or any combination of the preceding. Monitored conditions 150 may include vehicle conditions, external conditions, other condition, or any combination of the preceding.

A vehicle condition monitor provides vehicle conditions. Vehicle conditions describe conditions of the vehicle of the user that may affect travel along a route. According to one embodiment of the invention, vehicle conditions may describe the condition of an automobile. The conditions may describe whether the vehicle needs more fuel, requires servicing, or otherwise needs to vary from the route.

External condition monitors provide external conditions. External conditions describe conditions external to the vehicle that may affect travel along a route. For example, the conditions may describe the weather, traffic, or other condition that affects travel. External condition monitors may include a Global Positioning System (GPS), a waypoint monitor, other monitor, or any suitable combination of the preceding.

A Global Positioning System (GPS) may be used to monitor the location of the vehicle and to determine the location of points. A waypoint monitor may search for and may monitor waypoints that provide services. For example, a waypoint monitor may use information from waypoint descriptions and user preferences to search for preferred waypoints. A waypoint monitor may also monitor services provided by the waypoints. For example, a waypoint monitor may monitor reservations for the waypoints. If a waypoint changes a reservation, the waypoint monitor may inform the user and re-plan the journey. If the user changes a reservation for a waypoint, the waypoint monitor may inform the waypoint and re-plan the journey.

A rule 142 specifies an action to perform under a particular condition. Rules 142 may include service suggestion rules or service provider selection rules or both. A service suggestion rule may be used to suggest a service to a user, and may be classified according to the type of condition. For example, a rule may be classified according whether the rule is based on a location, preference, time, monitored condition, other condition, or any combination of the preceding.

A location-based rule specifies services for a location, such as a specific waypoint. An example rule may specify that a waypoint should have a particular kind of service. A time-based rule specifies services for a certain time. A time may be given as an objective time, such as a specific time of day, or as a relative time, such as the elapsed time from leaving a point. An example rule may specify that each meal time should have a restaurant service. Another example rule may specify that each night should have a hotel service. Another example rule may specify that every two hours should have a rest stop. Rules based on location, preference, or time may be applied to a user's itinerary to generate a journey.

A monitored condition-based rule specifies services for a monitored condition. An example rule may specify that if the user is approaching a restaurant that matches the user preferences, notify the user of the restaurant. Another example rule may specify that if the fuel level of the vehicle falls below a threshold value, search for a nearby gas station, notify the user, offer to provide navigational instructions to the gas station, or any combination of the preceding.

Another example rule may specify that if the tire pressure of a vehicle tire drops below a threshold value, search for a gas station with a tire pump facility, alert the user, offer to provide navigational instructions to the gas station, or any combination of the preceding. Another example rule may specify that if the mileage reaches a threshold value indicating that service is needed, search for a service center, alert the user, offer to provide navigational instructions to the user, or any combination of the preceding. These rules may be programmed into the vehicle by, for example, the manufacturer of the vehicle.

Service suggestion rules may be used to identify missing services. That is, if journey 10 fails to have a service specified by a service suggestion rule, the service may be regarded as missing.

A service provider selection rule may be used to select a service provider to provide the service. Selection rules may include, for example, service provider rules, bargaining rules, other rules for selecting a service provider, or any combination of the preceding.

A service provider rule describes a feature of a service provider. Service provider rules may include required rules and requested rules. A required rule may specify a feature for a service that is required to be satisfied by the service provider. Required rules may include, for example, the type of service, the time that the service is requested, and the location of the service. Requested rules may include features of the service that are requested, but need not be satisfied. Requested rules may include, for example, user preferences.

A bargaining rule describes the conditions of the bargaining process. Bargaining rules may include advertisement rules, bid rules, and evaluation rules. An advertisement rule describes how an advertisement should be generated from criteria, and may include information to be included in and to be requested by an advertisement. As an example, an advertisement may be required to include the required features of a service. As another example, an advertisement may be required to specify the bid rules and negotiation rules. As another example, an advertisement may be required to conform to journey parameters such as user preferences.

A bid rule describes the conditions of the bidding process. A bid rule may specify the time period during which bidding may occur. A bid rule may specify the information to be included in a bid. As an example, a bid may be required to include a proposed cost for the service and an indication of required and requested features of a service that the service provider proposes to satisfy.

A negotiation rule specifies how the service provider is to be selected from the bids. A negotiation rule may specify a bargaining strategy. Example bargaining strategies include a call for proposal, an English auction, a Dutch auction, other strategy, or any combination of the preceding. A negotiation rule may specify when to accept a bid. As an example, if the proposed costs for a service is high, the service may be assumed to be in high demand. Since the service is in high demand, a bid may be accepted earlier than if the service is in low demand.

Selection criteria may be categorized into particular contexts, such as business trip, road trip, airline vacation, ski trip, other example context, or any combination of the preceding. A context may describe the most common services of the context. As an example, an airline vacation context may include services for an outbound journey, a vacation day, and a return journey. Outbound journey services may include a taxi reservation from home to the airport, an outbound airline reservation, and a taxi reservation from the airport to the hotel. Vacation day services may include a morning activity, an afternoon activity, an evening activity, and a night hotel reservation. Return journey services may include a reservation from the hotel to the airport, a return airline reservation, and a taxi reservation from the airport to home.

According to one embodiment, a context may be used to suggest services for a journey. According to the embodiment, a journey parameters may be derived from a user's itinerary for the journey. The parameters may be analyzed to identify an appropriate context. The context may be applied to determine common services to suggest for the journey.

According to one embodiment, a customized template may be created for a context. The customized template may include specific fields associated with a particular context. A customized template may also have certain values already entered into the fields. As an example, a vacation template may values for airline and hotel reservation fields entered by a travel agent.

Bargaining module 126 manages applications that plan a journey. Bargaining module 126 may include any hardware, software, other logic, or combination of the preceding for managing the applications, and may use any of a variety of computing structures, arrangements, and compilations to manage the applications. According to the illustrated embodiment, bargaining module 126 includes a processor 162 and engines 166 coupled as shown.

According to the illustrated embodiment, engines 166 includes one or more information handlers 172, a suggestion engine 176, a selection engine 180, and a waypoint manager 184. An information handler 172 may provide an interface for between memory 122 or monitors 124 and suggestion engine 176 or selection engine 180. An information handler 172 may receive criteria from memory 122 or monitors 124, organize the criteria into information usable to engines 176 or 180, and provide the information to engines 176 or 180.

As an example, an itinerary handler may receive itinerary data, generate an itinerary from the data, and provide the itinerary to suggestion engine 176. As another example, a preference recommender determines services that may be preferred by the user. The user may input preferred services into the preference recommender, which in turn provides the preferred services to suggestion engine 176. Alternately, the preference recommender may compare service descriptions with user preferences to determine the preferred waypoints.

Suggestion engine 176 suggests a service in accordance with service selection criteria. A service may be suggested at any appropriate time. A service may be suggested at the beginning of journey 10. As an example, suggestion engine 176 may identify missing services, and then suggest the missing services. A service may be suggested at during journey 10. As an example, the service may be suggested according to a monitored condition-based rule when the monitored condition occurs.

Selection engine 180 selects a service provider. According to the embodiment, selection engine 180 may distribute advertisements requesting bids to provide service and select a service provider in response to the bids. The distribution and selection may be performed according to service provider selection criteria.

According to one embodiment, selection engine 180 may provide one or more selected service providers to the user. The selected service providers may be prioritized according to the compatibility of the service providers and the selection criteria. A service provider that is more compatible may be given a higher priority than one that is less compatible. Metrics may be used to calculate the compatibility of the waypoints. The metrics may comprise, for example, a suitability metric measuring how well the service provider matches the user preferences 140, a proximity metric measuring the distance between the service provider and the user, a satisfaction metric measuring how well the service provider satisfies requested or required rules, other metric, or any combination of the preceding.

Waypoint manager 184 manages the waypoints for journey 10, and may insert waypoints into a journey 10, modify waypoints, or remove waypoints. Waypoint manager module 184 inserts the selected service provider into journey 10. As an example, the selected service provider may be automatically inserted without approval from the user. As another example, multiple selected service providers may be suggested to the user. The user may approve a service provider. In response to the approval, the approved service provider may be automatically inserted into journey 10.

Modifications, additions, or omissions may be made to system 100 without departing from the scope of the invention. The components of system 100 may be integrated or separated according to particular needs. All or a portion of system 100 may be integrated as one or more independent devices, or may be integrated as a part of one or more other devices. For example, all or a portion of system 100 may be included as a component of a vehicle, a computer, a personal digital assistant, or other device.

Moreover, the operations of system 100 may be performed by more, fewer, or other modules. For example, the operations of suggestion engine 176 and selection engine 180 may be performed by one module, or the operations of suggestion engine 176 may be performed by more than one module. Additionally, operations of system 100 may be performed using any suitable logic comprising software, hardware, other logic, or any suitable combination of the preceding.

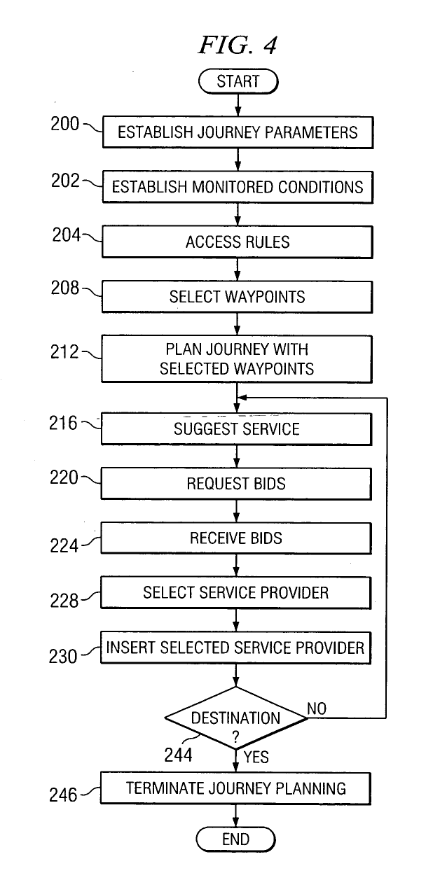

FIG. 4 is a flowchart illustrating one embodiment of a method for planning a journey that may be used with system 100 of FIG. 2. The method begins at step 200, where journey parameters are established. Journey parameters may include user preferences and route parameters. Monitored conditions are established at step 202. The monitored conditions may include vehicle conditions and external conditions, which may be obtained through monitors 124. Rules 146 are accessed at step 204. A rule may specify an action to be performed in response to a particular condition.

Waypoints 28 are selected at step 208. Waypoints 28 may be selected in accordance with the journey parameters. Journey 10 is planned with the selected waypoints at step 212. Services are suggested at step 216. Suggestion engine 176 may suggest a service that is missing from journey 10. Suggestion engine 176 may request approval from the user to search for a service provider for the service.

Selection engine 180 requests bids from service providers 62 at step 220. The request may conform to bidding rules, and the bids may be required to satisfy the bidding rules. An advertisement service 58 may be used to make the request available to service providers 62. Bids are received at step 224. The bids may be analyzed to determine whether they are legitimate. As an example, the bids may be required to have a certifiable digital signature.

Selection engine 180 selects a service provider at step 228 in accordance with the bids. The service provider may be selected according to bargaining rules. The selected service provider is inserted into journey 10 at step 230. The selected service provider may be inserted after approval from the user. According to one embodiment, approval may be sought after selecting service providers for one service or after selecting service providers for multiple services.

Destination 24 may be reached at step 244. If destination 24 is not reached, the method proceeds to step 216, where a next service is suggested. If destination 24 is reached at step 244, the method proceeds to step 246. Journey planning is terminated at step 246. After terminating journey planning, the method terminates.

Modifications, additions, or omissions may be made to the method without departing from the scope of the invention. The method may include more, fewer, or other steps. Additionally, steps may be performed in any suitable order without departing from the scope of the invention.

Certain embodiments of the invention may provide one or more technical advantages. A technical advantage of one embodiment may be that bids for providing a service for a user may be requested from a number of service providers. Accordingly, a number of service providers may compete to provide the service. Another technical advantage of one embodiment may be that the service providers may access advertisements requesting the bids. Accordingly, the service providers may readily identify users requesting their services.

While this disclosure has been described in terms of certain embodiments and generally associated methods, alterations and permutations of the embodiments and methods will be apparent to those skilled in the art. Accordingly, the above description of example embodiments does not constrain this disclosure. Other changes, substitutions, and alterations are also possible without departing from the spirit and scope of this disclosure, as defined by the following claims.

What is claimed is:

1. A method for planning a journey, comprising:
planning a journey from an origin to a destination;
suggesting a service along the journey;
requesting a plurality of bids for the service from a plurality of service providers;
receiving the plurality of bids for the service from the plurality of service providers;
evaluating the plurality of service providers in accordance with the plurality of bids; and
selecting one or more service providers of the plurality of service providers in response to the evaluation.

2. The method of claim 1, wherein requesting the plurality of bids for the service from the plurality of service providers further comprises:
requesting the plurality of bids after receiving approval for the service from a user.

3. The method of claim 1, wherein requesting the plurality of bids for the service from the plurality of service providers further comprises:
generating an advertisement requesting the plurality of bids; and
providing the advertisement to the plurality of service providers.

4. The method of claim 1, wherein evaluating the plurality of service providers in accordance with the plurality of bids further comprises:
determining the compatibility of each bid with selection criteria; and
evaluating the plurality of bids in accordance with the determination.

5. The method of claim 1, further comprising:
presenting a listing of the one or more service providers to a user; and
receiving approval for a service provider of the one or more service providers from the user.

6. The method of claim 1, further comprising:
prioritizing the one or more service providers; and
presenting a listing of the prioritized one or more service providers to a user.

7. A system for planning a journey, comprising:
a memory operable to store information; and
a processor coupled to the memory and operable to:
plan a journey from an origin to a destination;
suggest a service along the journey;
request a plurality of bids for the service from a plurality of service providers;
receive the plurality of bids for the service from the plurality of service providers;
evaluate the plurality of service providers in accordance with the plurality of bids; and
select one or more service providers of the plurality of service providers in response to the evaluation.

8. The system of claim 7, the processor further operable to request the plurality of bids for the service from the plurality of service providers by:
requesting the plurality of bids after receiving approval for the service from a user.

9. The system of claim 7, the processor further operable to request the plurality of bids for the service from the plurality of service providers by:
generating an advertisement requesting the plurality of bids; and
providing the advertisement to the plurality of service providers.

10. The system of claim 7, the processor further operable to evaluate the plurality of service providers in accordance with the plurality of bids by:
determining the compatibility of each bid with selection criteria; and
evaluating the plurality of bids in accordance with the determination.

11. The system of claim 7, the processor further operable to:
present a listing of the one or more service providers to a user; and
receive approval for a service provider of the one or more service providers from the user.

12. The system of claim 7, the processor further operable to:
prioritize the one or more service providers; and
present a listing of the prioritized one or more service providers to a user.

13. Logic for planning a journey, the logic embodied in a medium and operable to:
plan a journey from an origin to a destination;
suggest a service along the journey;
request a plurality of bids for the service from a plurality of service providers;
receive the plurality of bids for the service from the plurality of service providers;
evaluate the plurality of service providers in accordance with the plurality of bids; and
select one or more service providers of the plurality of service providers in response to the evaluation.

14. The logic of claim 13, further operable to request the plurality of bids for the service from the plurality of service providers by:
requesting the plurality of bids after receiving approval for the service from a user.

15. The logic of claim 13, further operable to request the plurality of bids for the service from the plurality of service providers by:
generating an advertisement requesting the plurality of bids; and
providing the advertisement to the plurality of service providers.

16. The logic of claim 13, further operable to evaluate the plurality of service providers in accordance with the plurality of bids by:
determining the compatibility of each bid with selection criteria; and
evaluating the plurality of bids in accordance with the determination.

17. The logic of claim 13, further operable to:
present a listing of the one or more service providers to a user; and
receive approval for a service provider of the one or more service providers from the user.

18. The logic of claim 13, further operable to:
prioritize the one or more service providers; and
present a listing of the prioritized one or more service providers to a user.

19. A system for planning a journey, comprising:
means for planning a journey from an origin to a destination;
means for suggesting a service along the journey;
means for requesting a plurality of bids for the service from a plurality of service providers;
means for receiving the plurality of bids for the service from the plurality of service providers;
means for evaluating the plurality of service providers in accordance with the plurality of bids; and
means for selecting one or more service providers of the plurality of service providers in response to the evaluation.

20. A method for planning a journey, comprising:
planning a journey from an origin to a destination;
suggesting a service along the journey;
requesting a plurality of bids for the service from a plurality of service providers;
receiving the plurality of bids for the service from the plurality of service providers, requesting the plurality of bids further comprising:
requesting the plurality of bids after receiving approval for the service from a user;
generating an advertisement requesting the plurality of bids; and
providing the advertisement to the plurality of service providers;
evaluating the plurality of service providers in accordance with the plurality of bids, evaluating the plurality of service further comprising:
determining the compatibility of each bid with selection criteria; and
evaluating the plurality of bids in accordance with the determination;
selecting one or more service providers of the plurality of service providers in response to the evaluation;
prioritizing the one or more service providers; and
presenting a listing of the prioritized one or more service providers to the user; and
receiving approval for a service provider of the one or more service providers from the user.
